(19) United States
(12) Patent Application Publication
(10) Pub. No.: US 2006/0010160 A1
(43) Pub. Date: Jan. 12, 2006

(54) Information processing apparatus, storage device, storage control apparatus, and computer program product

(75) Inventors: Nobuya Kishi, Nara (JP); Akira Hamada, Osaka (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/176,477

(22) Filed: Jul. 6, 2005

(30) Foreign Application Priority Data
Jul. 6, 2004 (JP) 2004-199781

(51) Int. Cl. G06F 17/30

(52) U.S. Cl. 707/102

(57) ABSTRACT

A CPU (information processing unit) outputs file specification of data and an erasing instruction of data to an HDD controller (storage control apparatus, storage control unit). The HDD controller specifies a cluster into which overwriting data corresponding to a file should be written, and generates the overwriting data, and outputs specification of a cluster, the overwriting data, an overwriting instruction, and an instruction for invalidating entry information and FAT information (correspondence information) to an HDD (storage unit, storage means). The HDD writes the overwriting data into the specified cluster to erase the data, and invalidates the entry information and the FAT information. Accordingly, a burden on a process required for erasing stored data can be reduced.

### CROSS-REFERENCE TO RELATED APPLICATIONS

This nonprovisional application claims priority under 35 U.S.C. §119 (a) on Patent Application No. 2004-199781 filed in Japan on Jul. 6, 2004, the entire contents of which are hereby incorporated by reference.

### BACKGROUND OF THE INVENTION

1. Field of the Invention

The invention relates to an information processing apparatus, storage device, storage control apparatus and computer program product capable of reducing a burden on a process required for erasing stored data.

2. Description of Related Art

There has been practically used an image processing apparatus having plural functions such as a copying function of scanning an original to duplicate images, a function as a network printer for receiving image data from an external apparatus such as a personal computer (PC) to output an image, and a function as a facsimile machine for transmitting/receiving image data to/from an external facsimile machine over facsimile communication. Such image processing apparatus includes a storage device such as a hard disk drive for temporarily storing the image data to be processed. Also, an apparatus such as a PC or a server includes a storage device such as a hard disk drive for storing information. While the image processing apparatus, the PC, the server, or any other information processing apparatus includes a control apparatus such as a CPU for performing an information process, its storage device is operated by the control apparatus for storing the information.

In some cases, the image processing apparatus or the information processing apparatus such as a PC or a server processes confidential information such as a document in which personal information or company information is described. When such confidential information remains stored in the storage device of the information processing apparatus, it may possibly be thieved and leaked out. For prevention, an attempt has been introduced to a practice for writing nonsense data over the confidential data stored in a recording region of the storage device upon completion of the data processing of an information processing apparatus.

A method for erasing information stored in a storage device of an information processing apparatus will now be described. FIG. 1 is a block diagram showing an internal configuration of a conventional information processing apparatus. The information processing apparatus comprises a CPU 61 for processing information. The CPU 61 is connected with a system controller 62 for inputting/outputting data to/from the CPU 61. The system controller 62 is connected with a RAM 63 for temporarily storing data accompanying with the process performed by the CPU 61, and a bus B. The bus B is connected with an I/O controller 64 for inputting/outputting data to/from the bus B. The I/O controller 64 is connected with an external interface 67 for inputting/outputting data to/from apparatuses outside the information processing apparatus, and a hard disk drive (HDD) 66 for storing the data. The I/O controller 64 also has an HDD controller 65 for controlling input/output of data between the HDD 66 and the bus B.

The data stored in the HDD 66 is managed on a file basis with the use of a file system such as a FAT (File Allocation Table). The HDD 66 stores data on a file basis, such as image data, and correspondence information indicative of a sector, in which data included in the file is stored, in the HDD 66. When FAT is used as the file system, the correspondence information includes entry information and FAT information of the files. The entry information contains a file name for identifying each file and information indicative of a start cluster from which the file is stored. The FAT information contains information indicative of clusters in which the file is stored.

FIG. 2A, FIG. 2B and FIG. 2C are conceptual diagrams showing examples of the data stored in the HDD 66 of the conventional information processing apparatus. More specifically, FIG. 2A illustrates an example of the entry information, FIG. 2B illustrates an example of the FAT information, and FIG. 2C illustrates an example of the data in the file. In this example, the entry information shows that the start cluster of the file A is denoted by (0010). The FAT information shows that linkage is made from the cluster (0010) to a cluster (0011) and from (0011) to (0013). The cluster (0013) is denoted by EOF (End of File) indicating that the cluster (0013) is the final cluster of the file A. The FAT information also shows that a cluster (0012) is a bad cluster. As shown by the entry information and the FAT information, the file A is divided into three segments of cluster size data which are stored as the first, second and third (last), data of the file A in the clusters (0010), (0011) and (0013) of the HDD 66 respectively.

The file A is read out by the CPU 61 performing the following procedures. The CPU 61 refers to the entry information to acquire the start cluster (0010) of the file A, and refers to the FAT information to obtain that the file A is stored in the clusters (0010), (0011) and (0013), thereby reading out the data from the clusters (0010), (0011) and (0013) of the HDD 66.

FIG. 3A and FIG. 3B are schematic diagram conceptually showing processes of deleting, and overwriting and erasing data stored in the HDD 66 of the conventional information processing apparatus. More specifically, FIG. 3A illustrates the process of deleting the data and FIG. 3B illustrates the process of overwriting and erasing the data. For deleting the data of the file A, the CPU 61 issues to the HDD 66 an instruction for invalidating both the entry information and the FAT information via the HDD controller 65. As the linkage in its FAT information between the clusters have been cleared off and its entry information has been canceled by the invalidating command, the file A is apparently deleted.

However, the data remains intact as stored in the HDD 66. Accordingly, in the information processing apparatus which processes confidential information, it is necessary for intending security by erasing the data itself with use of overwriting. In the case of overwriting and erasing of the file A, as shown in FIG. 3B, the CPU 61 designates the clusters of the data to be overwritten, generates overwriting data, writes the overwriting data into the designated cluster, and at last invalidates both the entry information and the FAT information. With this overwriting and erasing process, data itself in the HDD 66 is completely erased, so that information can be actually erased.

A technique of erasing the information stored in a storage device is disclosed in Japanese Patent Application Laid-Open No. 01-053241 (1989) where the directory region and the data region pertinent to the directory region of a file of the data are written with dedicated codes for erasing the data. Another technique is disclosed in Japanese Patent Application Laid-Open No. 05-205285 (1993) which has a storage device provided with plural heads capable of accessing plural areas of a recording medium thus to perform recording, reproducing and erasing of information in parallel.

In the aforementioned conventional techniques, however, the CPU in the information processing apparatus needs to perform designation of a cluster to be overwritten and a process of generating overwriting data. The process of overwriting and erasing information stored in the storage unit will exert a burden on the CPU. Also, the overwriting data has to be transferred from the CPU to the storage unit whenever the process of erasing the information is desired. This increases the transfer amount of data between the CPU and the storage unit. As the transfer amount of data between the CPU and the storage unit is increased for erasing data, the information processing apparatus will hence be declined in the efficiency and speed of the processing operation. When the CPU is employed with high processabilitiy for avoiding such declination in the efficiency and speed of the processing operation, the overall cost of the information processing apparatus will increase.

### BRIEF SUMMARY OF THE INVENTION

The invention has been accomplished in view of the aforementioned circumstances, and an object thereof is to provide an information processing apparatus, storage device, storage control apparatus and computer program product capable of reducing a burden on a CPU such that other parts perform a process required for erasing data in place of the CPU.

An information processing apparatus according to the invention comprises: an information processing unit which processes information; a storage unit which stores data on a file basis; and a storage control unit which is connected to the information processing unit and the storage unit and controls input/output of information to/from the storage unit, and is characterized in that the information processing unit comprises means for outputting, to the storage control unit, file designating information for designating a file and a file erasing instruction for instructing erasing of a file designated by the file designating information, the storage control unit comprises: address specifying means for specifying an address in the storage unit storing data of a file designated by the file designating information outputted from the information processing unit; data generating means for generating overwriting data for overwriting and erasing data; and means for, in accordance with a file erasing instruction outputted from the information processing unit, outputting, to the storage unit, overwriting data generated by the data generating means, address designating information for designating an address of the storage unit specified by the address specifying means, and a data writing instruction for instructing writing of the overwriting data into the address, and the storage unit comprises means for, in accordance with a data writing instruction outputted from the storage control unit, writing the overwriting data outputted from the storage control unit into an address designated by the address designating information outputted from the storage control unit.

The above mentioned information processing apparatus according to the invention comprises the information processing unit, the storage unit (external storage device) such as a hard disk drive, and the storage control unit (storage control apparatus) for controlling input/output of information to/from the storage unit. When data stored in the storage unit is overwritten and erased, the information processing unit designates a file to be erased, the storage control unit specifies an address of the storage unit storing the data of the file and, also, generates overwriting data, and the storage unit writes the overwriting data into the specified address, thereby overwriting and erasing the data.

In the conventional technique, upon overwriting and erasing data, an information processing unit generates overwriting data, directly designates a cluster and writes the overwriting data. In contrast, according to the information processing apparatus of the invention, the storage control unit (storage control apparatus) performs a main process for erasing data in place of the information processing unit; therefore, a burden on the information processing unit required for overwriting and erasing data is reduced, and a transfer amount of data between the information processing unit and the storage control unit is reduced. Accordingly, processing efficiency and processing speed of the information processing apparatus are improved. Moreover, since it is unnecessary to use an information processing unit with high processability, it is possible to suppress increase in cost of the information processing apparatus.

An information processing apparatus according to the invention comprises: an information processing unit which processes information; a storage unit which stores data on a file basis; and a storage control unit which is connected to the information processing unit and the storage unit and controls input/output of information to/from the storage unit, and is characterized in that the information processing unit comprises means for outputting, to the storage control unit, file designating information for designating a file and a file erasing instruction for instructing erasing of a file designated by the file designating information, the storage control unit comprises: address specifying means for specifying an address in the storage unit storing data of a file designated by the file designating information outputted from the information processing unit; and means for, in accordance with a file erasing instruction outputted from the information processing unit, outputting, to the storage unit, address designating information for designating an address of the storage unit specified by the address specifying means, and a data writing instruction for instructing writing of overwriting data for overwriting and erasing data into the address, and the storage unit comprises: data generating means for generating overwriting data; and means for, in accordance with a data writing instruction outputted from the storage control unit, writing overwriting data generated by the data generating means into an address designated by the address designating information outputted from the storage control unit.

The above mentioned information processing apparatus according to the invention comprises the information processing unit, the storage unit (external storage device) such as a hard disk drive, and the storage control unit (storage control apparatus) for controlling input/output of information to/from the storage unit. When data stored in the storage unit is overwritten and erased, the information processing unit designates a file to be erased, the control unit specifies an address of the storage unit storing the data of the file, and the storage unit generates overwriting data and, also, writes the overwriting data into the specified address by itself, thereby overwriting and erasing the data.

According to the information processing apparatus of the invention, since the storage unit (external storage device) generates the overwriting data by itself, a burden on the information processing unit required for overwriting and erasing data is reduced, and a transfer amount of data between the storage control unit and the storage unit is reduced. Accordingly, efficiency for inputting/outputting information to/from a device other than the storage unit can be improved.

A storage device according to the invention comprises: a storage unit which stores data on a file basis; and a storage control unit which is connected to the storage unit and controls input/output of information to/from the storage unit, and is characterized in that the storage control unit comprises: receiving means for receiving, from the outside, file designating information for designating a file, and a file erasing instruction for instructing erasing of a file designated by the file designating information; address specifying means for specifying an address of the storage unit storing data of a file designated by the file designating information received by the receiving means; data generating means for generating overwriting data for overwriting and erasing data; and means for, in accordance with a file erasing instruction received by the receiving means, outputting, to the storage unit, overwriting data generated by the data generating means, address designating information for designating an address of the storage unit specified by the address specifying means, and a data writing instruction for instructing writing of the overwriting data into the address, and the storage unit comprises means for, in accordance with a data writing instruction outputted from the storage control unit, writing overwriting data outputted from the storage control unit into an address designated by address designating information outputted from the storage control unit.

A storage device according to the invention comprises: a storage unit which stores data on a file basis; and a storage control unit which is connected to the storage unit and controls input/output of information to/from the storage unit, and is characterized in that the storage control unit comprises: receiving means for receiving, from the outside, file designating information for designating a file, and a file erasing instruction for instructing erasing of a file designated by the file designating information; address specifying means for specifying an address of the storage unit storing data of a file designated by the file designating information received by the receiving means; and means for, in accordance with a file erasing instruction received by the receiving means, outputting, to the storage unit, address designating information for designating an address of the storage unit specified by the address specifying means, and a data writing instruction for instructing writing of overwriting data for overwriting and erasing data into the address, and the storage unit comprises: data generating means for generating overwriting data; and means for, in accordance with a data writing instruction outputted from the storage control unit, writing overwriting data generated by the data generating means into an address designated by the address designating information outputted from the storage control unit.

According to the above mentioned storage device of the invention, a storage device which configures the aforementioned information processing apparatus can be realized.

A storage control apparatus according to the invention can be connected to an external storage device for storing data on a file basis and controls input/output of information to/from the connected external storage device, and is characterized by comprising: receiving means for receiving, from the outside, file designating information for designating a file stored in the external storage device, and a file erasing instruction for instructing erasing of a file designated by the file designating information; address specifying means for specifying an address of the external storage device storing data of a file designated by the file designating information received by the receiving means; data generating means for generating overwriting data for overwriting and erasing data; and transmitting means for, in accordance with a file erasing instruction received by the receiving means, transmitting, to the external storage device, overwriting data generated by the data generating means, address designating information for designating an address of the external storage device specified by the address specifying means, and a data writing instruction for instructing writing of the overwriting data into the address.

A storage control apparatus according to the invention can be connected to an external storage device for storing data on a file basis and controls input/output of information to/from the connected external storage device, and is characterized in that the storage control apparatus can be connected to an external storage device having means for generating overwriting data for overwriting and erasing data, and comprises: receiving means for receiving, from the outside, file designating information for designating a file stored in the connected external storage device, and a file erasing instruction for instructing erasing of a file designated by the file designating information; address specifying means for specifying an address of the external storage device storing data of a file designated by the file designating information received by the receiving means; and transmitting means for, in accordance with a file erasing instruction received by the receiving means, transmitting, to the external storage device, address designating information for designating an address of the external storage device specified by the address specifying means, and a data writing instruction for instructing generation of overwriting data and writing of the generated overwriting data into the address.

According to the above mentioned storage control apparatus of the invention, a storage control apparatus which configures the aforementioned information processing apparatus can be realized.

A storage control apparatus according to the invention is, in the above mentioned storage control apparatus, characterized in that the external storage device stores correspondence information for corresponding a file and an address storing the file to each other, and the storage control apparatus further comprises transmitting means for transmitting a canceling instruction, which instructs that the correspondence information stored in the external apparatus is updated so that the correspondence between a file designated by the file designating information and an address storing the file is canceled, to the external storage device after completion of writing of the overwriting data.

In the above mentioned storage control apparatus of the invention, the storage unit stores the correspondence information which corresponds a file and an address storing the file to each other, and after the writing of the overwriting data into the address of the storage unit, the storage control unit cancels the correspondence between the file and the address included in the correspondence information.

According to the storage control apparatus of the invention, the association between the file and the address included in the correspondence information is canceled after the writing of the overwriting data, and the overwritten and erased data is invalidated. As a result, a portion of the storage unit where the data is overwritten and erased can readily be used for storing new data.

A storage control apparatus according to the invention is, in the above mentioned storage control apparatus, characterized by further comprising transmitting means for transmitting a writing instruction, which instructs that erasure request information indicative of a request for erasing a file designated by the file designating information is written into the correspondence information stored in the external storage device in association with the file, to the external storage device prior to transmission of the data writing instruction by the transmitting means.

In the above mentioned storage control apparatus of the invention, the erasure request information indicative of a request for erasing a file is written into the correspondence information prior to the writing of the overwriting data.

A storage control apparatus according to the invention is, in the above mentioned storage control apparatus, characterized by further comprising: correspondence information reading means for, upon power-on, reading out the correspondence information stored in the external storage device; judging means for judging whether or not the correspondence information read by the correspondence information reading means includes the erasure request information; and means for, when the judging means judging that the correspondence information includes the erasure request information, performing the same process as that in the case where the receiving means receives a file erasing instruction for instructing erasing of a file associated with the erasure request information by the correspondence information.

In the above mentioned storage control apparatus of the invention, it is judged, upon power-on, whether or not the erasure request information is included in the correspondence information. When the erasure request information is included in the correspondence information, a file associated with the erasure request information by the correspondence information is overwritten and erased.

According to the storage control apparatus of the invention, the erasure request information is recorded in the correspondence information in association with the name of file to be erased before the overwriting data is overwritten into the data of the file to be erased. When a file associated with the erasure request information by the correspondence information exists upon power-on, data of the file can be overwritten and erased at the same timing. Accordingly, the data to be erased can readily be overwritten and erased at the subsequent power-on even when the information processing apparatus is stopped due to power failure and the like during the overwriting and erasing process, thus contributing to the improvement of security in the information processing apparatus.

A storage control apparatus according to the invention is, in the above mentioned storage control apparatus, is characterized in that the receiving means receives, from the outside, an erasing method instruction for instructing a method for erasing a file together with the file erasing instruction, and the transmitting means transmits the data writing instruction, which instructs that the overwriting data is written into the address by a method realizing the method in accordance with the erasing method instruction, to the external storage device.

In the above mentioned storage control apparatus of the invention, the erasing method instruction for instructing a method for erasing data, such as the type of overwriting data or the number of times of overwriting, is given and used for performing the overwriting and erasing process.

According to the storage control apparatus of the invention, the overwriting and erasing process is performed in accordance with the instructed method, whereby the degree of importance for erasing the data can be adjusted on the basis of the content or security level of the data.

A storage control apparatus according to the invention is, in the above mentioned storage control apparatus, characterized by further comprising: file erasing instruction storing means for storing plural file erasing instructions received by the receiving means in a receiving order; and means for performing processes in accordance with plural file erasing instructions stored in the file erasing instruction storing means in the stored order.

In the above mentioned storage control apparatus of the invention, plural erasing instructions are stored in a receiving order and used for performing the overwriting and erasing processes in the same order.

According to the storage control apparatus of the invention, the overwriting and erasing processes are performed in the receiving order of the plural erasing instructions, whereby plural files to be erased can readily be erased in a succession.

A storage control apparatus according to the invention is, in the above mentioned storage control apparatus, characterized by capable of controlling input/output of information to/from the external storage device by plural control methods, and further comprises: means for receiving, from the outside, control information relating to input/output of information to/from the external storage device; and means for setting a control method for controlling the external storage device by a control method according to the control information received by the means.

In the above mentioned storage control apparatus of the invention, the input/output of information to/from the storage unit can be controlled by the plural control methods. Consequently, as the control information for controlling the input/output of information to/from the storage unit, such as formatting of the storage unit, the control methods are set such that the input/output of the information can be controlled by the control method according to the control information.

According to the storage control apparatus of the invention, the input/output of information to/from the storage unit is controlled by the control method according to the file system to be used; therefore, this process does not depend on the type of the file system. As a result, the storage control unit, the storage device, or the information processing unit comprising them are applicable to various information processing apparatuses such as a PC, a server and an image processing apparatus, with no need of their selective employment depending on the applications.

A computer program product according to the invention is a computer program product for controlling a computer which is connected with an external storage device for storing data on a file basis and inputs/outputs information to/from the external storage device, wherein the computer program product comprises: a computer readable storage medium having computer readable program code means embodied in the medium, the computer readable program code means comprising computer instruction means for: when receiving, from the outside, file designating information for designating a file stored in the external storage device, and a file erasing instruction for instructing erasing of a file designated by the file designating information, specifying an address of the external storage device storing data of a file designated by the received file designating information; generating overwriting data for overwriting and erasing data; and transmitting, in accordance with the received file erasing instruction, to the external storage device, generated overwriting data, address designating information designating a specified address of the external storage device, and a data writing instruction for instructing writing of the overwriting data into the address.

A computer program product according to the invention is a computer program product for controlling a computer which is connected with an external storage device for storing data on a file basis and inputs/outputs information to/from the external storage device, wherein the computer program product comprises: a computer readable storage medium having computer readable program code means embodied in the medium, the computer readable program code means comprising computer instruction means for: when receiving, from the outside, file designating information for designating a file stored in an external storage device which generates overwriting data for overwriting and erasing data, and a file erasing instruction for instructing erasing of a file designated by the file designating information, specifying an address of the external storage device storing data of a file designated by the received file designating information; and transmitting, in accordance with the received file erasing instruction, to the external storage device, address designating information designating a specified address of the external storage device, and a data writing instruction for instructing generation of overwriting data and writing of the overwriting data into the address.

According to the computer program product of the invention, a general purpose computer can function as the aforementioned information processing apparatus of the invention.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing an internal configuration of a conventional information processing apparatus;

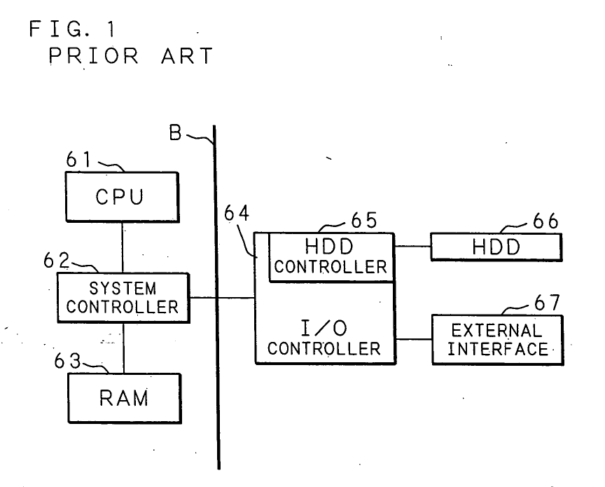

FIG. 2A, FIG. 2B and FIG. 2C are conceptual diagrams each showing an example of data stored in an HDD of the conventional information processing apparatus;

FIG. 3A is a schematic diagram conceptually showing a process of deleting data stored in the HDD of the conventional information processing apparatus, and FIG. 3B is a schematic diagram conceptually showing a process of overwriting and erasing the data;

FIG. 4A and FIG. 4B are block diagrams each showing an internal configuration of an information processing apparatus according to Embodiment 1 of the invention;

FIG. 5 is a functional block diagram showing configurations of an HDD controller and an HDD of the information processing apparatus according to Embodiment 1 of the invention;

FIG. 6 is a flowchart showing data erasing procedures performed by the information processing apparatus according to Embodiment 1 of the invention;

FIG. 7 is a flowchart showing data erasing procedures performed by the information processing apparatus according to Embodiment 1 of the invention;

FIG. 8 is a conceptual diagram showing an example of entry information into which erasure request information for the information processing apparatus according to Embodiment 1 of the invention is written;

FIG. 9A, FIG. 9B and FIG. 9C are conceptual diagrams each showing an example of data after overwritten and erased stored in the HDD of the information processing apparatus according to Embodiment 1 of the invention;

FIG. 10 is a schematic diagram conceptually showing a process of overwriting and erasing data in the information processing apparatus according to Embodiment 1 of the invention;

FIG. 11 is a flowchart showing procedures performed upon power-on by the information processing apparatus according to Embodiment 1 of the invention;

FIG. 12 is a flowchart showing procedures of setting a controlling method by the HDD controller as a storage control unit according to Embodiment 1 of the invention;

FIG. 13 is a functional block diagram showing functions of an HDD controller and an HDD of an information processing apparatus according to Embodiment 2 of the invention; and

FIG. 14 is a schematic diagram conceptually showing a process of overwriting and erasing data in Embodiment 2 of the invention.

### DETAILED DESCRIPTION OF THE PREFERRED EMBODIMENTS

Hereinafter, the invention will be described in detail with reference to the drawings showing preferred embodiments thereof.

### Embodiment 1

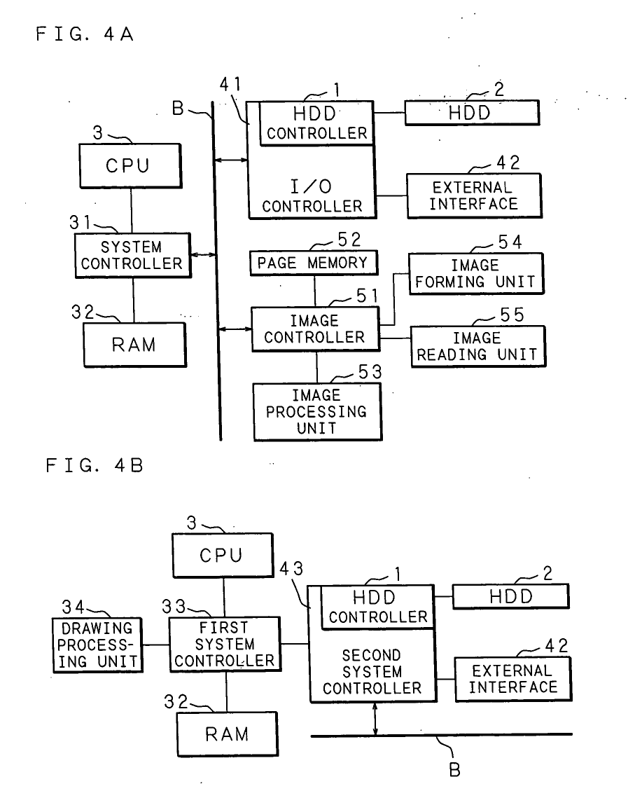

FIG. 4A and FIG. 4B are block diagrams each showing an internal configuration of an information processing apparatus according to Embodiment 1 of the invention. FIG. 4A illustrates an internal configuration in a case where the information processing apparatus is an image processing apparatus while FIG. 4B illustrates an internal configuration in a case where the information processing apparatus is a personal computer (PC).

In the case where the information processing apparatus is an image processing apparatus as shown in FIG. 4A, the information processing apparatus comprises a CPU 3 for processing information. The CPU 3 is connected with a system controller 31 for controlling input/output of data to/from the CPU 3. The CPU 3 functions as an information processing unit. The system controller 31 is connected with a RAM 32 for temporarily storing data accompanying with a process performed by the CPU 3, and a bus B. The bus B is connected with an I/O controller 41 for controlling input/output of data to/from the bus B, and an image controller 51. The image controller 51 is connected with an image reading unit 55 for reading an image recorded on an original, a page memory 52 for storing image data on a page basis, an image processing unit 53 for processing the image data, and an image forming unit 54 for forming an image from the image data and outputting the image. The I/O controller 41 is connected with an external interface 42 for inputting/outputting data to/from an apparatus outside the information processing apparatus, and a hard disk drive (HDD) 2 for storing data. The HDD 2 functions as a storage unit or an external storage device. The I/O controller 41 includes an HDD controller 1 for controlling input/output of data between the HDD 2 and the bus B. The HDD controller 1 functions as a storage control apparatus or a storage control unit.

In the case where the information processing apparatus is a PC as shown in FIG. 4B, the information processing apparatus comprises a CPU 3 for processing information. The CPU 3 is connected with a first system controller 33 for controlling input/output of data to/from the CPU 3. The first system controller 33 is connected with a RAM 32, and a drawing processing unit 34 for drawing an image to be outputted to a display. The first system controller 33 is also connected with a second system controller 43 for controlling input/output of data to/from the first system controller 33. The second system controller 43 includes an HDD controller 1. The second system controller 43 is connected with an external interface 42.

In both of the information processing apparatuses, the CPU 3 stores necessary data in the HDD 2 and performs an information process such as an image process with the use of the data stored in the HDD 2. Upon completion of the information process with the use of the data stored in the HDD 2, the CPU 3 performs a process of overwriting and erasing the data stored in the HDD 2.

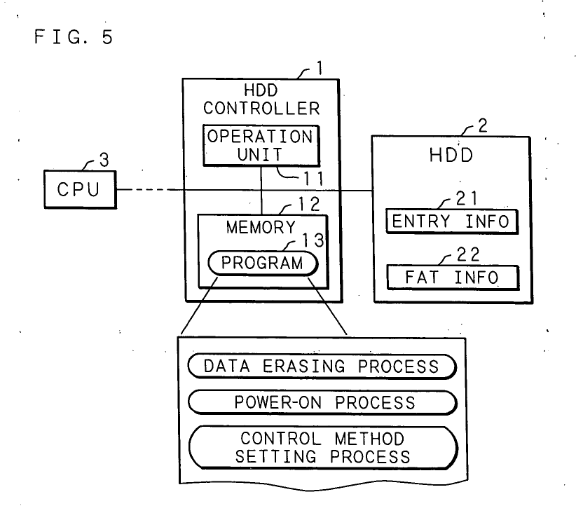

FIG. 5 is a functional block diagram showing configurations of the HDD controller 1 and the HDD 2 according to Embodiment 1. The HDD controller 1 comprises an operation unit 11 composed of a CPU or the like, and a memory 12 connected to the operation unit 11. The memory 12 is of a nonvolatile type such as a flash memory, and stores a computer program 13 according to the invention. The operation unit 11 is connected with the HDD 2, and is also connected with the CPU 3 via the system controller 31 and the like. In the case where the operation unit 11 performs a process of controlling input/output of information to/from the HDD 2 as an external storage device in accordance with the program 13, the HDD controller 1 functions as a storage control apparatus. A form that the HDD controller 1 as a storage control unit and the HDD 2 as a storage unit are connected to each other corresponds to a storage device according to the invention. The HDD 2 stores data received via the HDD controller 1 and the like from the CPU 3 and, also, stores entry information 21 and FAT information 22 as association information.

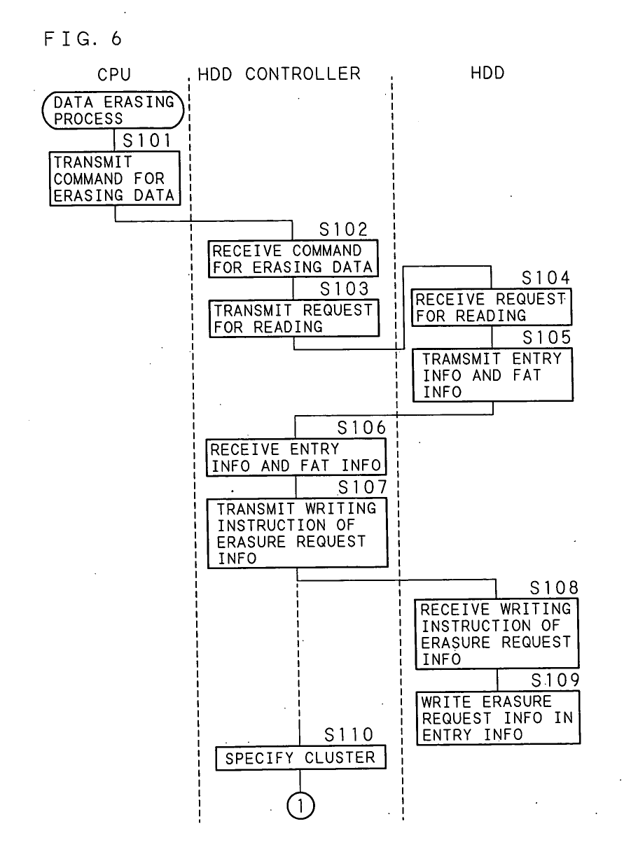

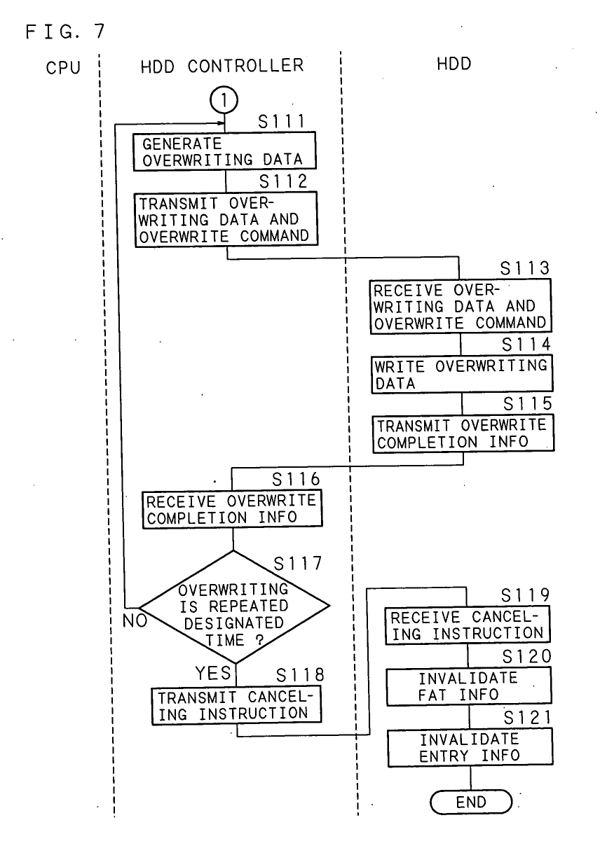

Then, the processes performed by the information processing apparatus according to Embodiment 1 of the invention will now be described with reference to flowcharts. FIG. 6 and FIG. 7 are flowcharts each showing data erasing procedures performed by the information processing apparatus according to Embodiment 1 of the invention.

After completion of the information process such as output of an image, the CPU 3 transmits a command for erasing the data used for the information process to the HDD controller 1 (S101). This erasing command includes file designating data for designating a file of the data, and an instruction for erasing the designated file, and also an erasing method instruction for instructing a file erasing method such as the type of overwriting data and the number of overwriting. The HDD controller 1 receives the erasing command of data (S102), and transmits to the HDD 2 a request for reading the entry information 21 and the FAT information 22 stored in the HDD 2 (S103). The HDD 2 receives the reading request (S104), and transmits the entry information 21 and the FAT information 22, which are stored in the HDD 2 itself, to the HDD controller 1 (S105).

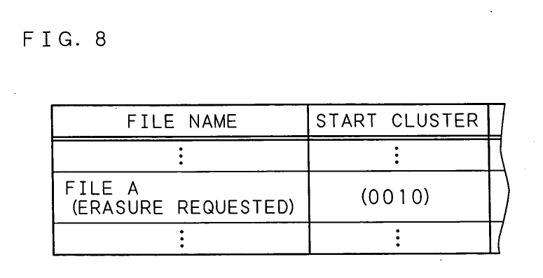

The HDD controller 1 receives the entry information 21 and the FAT information 22 from the HDD 2 (S106), and transmits to the HDD 2 a writing instruction for instructing that erasure request information indicative of a request for erasing a file is written into the entry information 21 in association with the file designated by the file designating information included in the erasing command (S107). The HDD 2 receives the writing instruction of the erasure request information (S108), and writes the erasure request information into the entry information 21 in association with the specified file (S109). FIG. 8 is a conceptual diagram showing an example of the entry information 21 into which the erasure request information is written. Information for “requesting erasure” indicative of a request for erasing data is recorded in a file name of the entry information in which a file name of data and a start cluster of a file correspond to each other.

Then, the HDD controller 1 compares the entry information 21 and the FAT information 22 with the file designating information included in the erasing command of data to specify the clusters (address) in the HDD 2 storing the data to be erased (S110). In accordance with the erasing method instruction included in the erasing command of data received from the CPU 3, the HDD controller 1 generates overwriting data for overwriting and erasing data (S111). As the overwriting data herein, data of all “0” or nonsense data such as random data utilizing random number is generated in accordance with the erasing method instruction. The HDD controller 1 transmits to the HDD 2 an overwriting command for instructing overwriting of the data with the generated overwriting data (S112). The overwriting command includes cluster designating information (address designating information) for designating the clusters specified in step S110, and a data writing instruction for instructing writing of the overwriting data into the clusters designated by the cluster designating information.

The HDD 2 receives the overwriting data and the overwriting command (S113), writes the received overwriting data into the clusters designated by the cluster designating information included in the overwriting command (S114), and transmits to the HDD controller 1 overwriting completion information indicative of completion of writing of the overwriting data (S115).

The HDD controller 1 receives the overwriting completion information (S116), and judges whether or not the overwriting is repeated a number of times designated by the erasing method instruction included in the erasing command of data (S117). When the overwriting is not repeated the designated number of times (NO in S117), the HDD controller 1 returns the process to step S111 to repeat the overwriting. When the overwriting is repeated the designated number of times (YES in S117), the HDD controller 1 transmits a canceling instruction for instructing cancel of the correspondence between the file and the clusters recorded in the entry information 21 and the FAT information 22 (S118).

The HDD 2 receives the canceling instruction (S119), and cancels the linkage between the clusters in which the overwritten and erased data is stored included in the FAT information 22 in accordance with the canceling instruction to invalidate contents of the FAT information 22 regarding the overwritten and erased data (S120). The HDD 2 changes the file name of the overwritten and erased data to its erased state in the entry information 21 in accordance with the canceling instruction, thereby invalidating contents of the entry information 22 regarding the overwritten and erased data (S121). Thus, the process of erasing the data is ended.

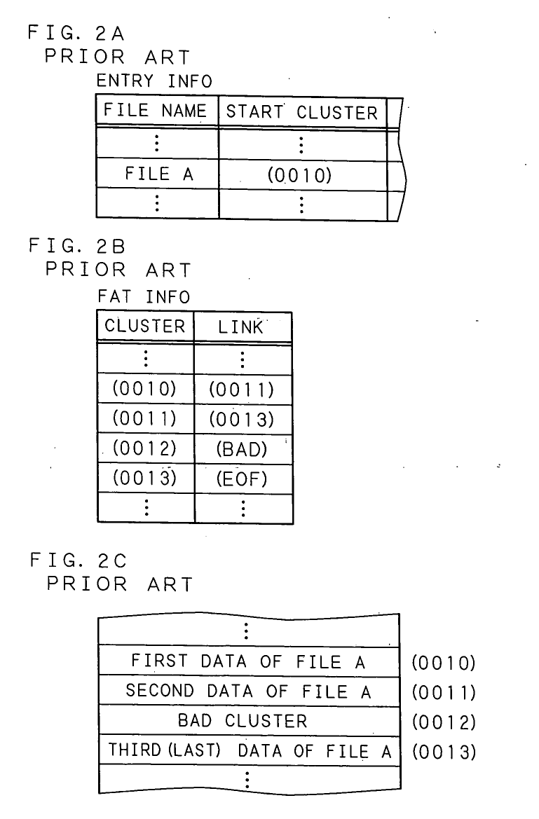

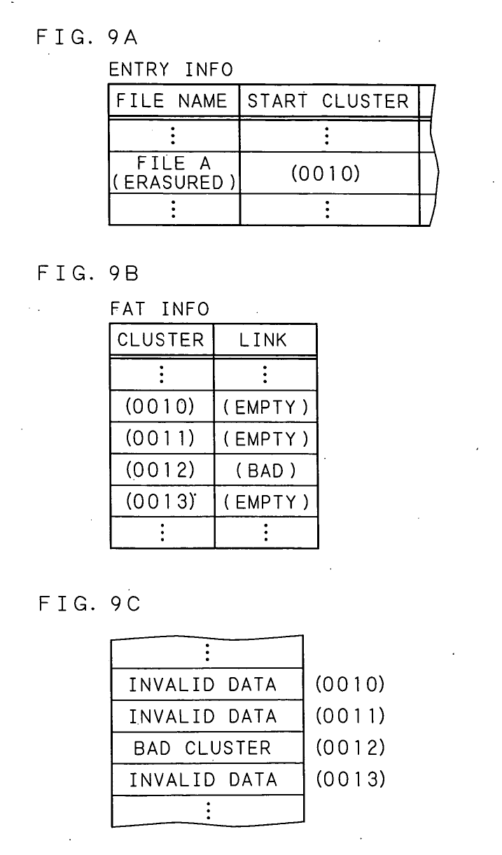

FIG. 9A, FIG. 9B and FIG. 9C are conceptual diagrams each showing an example of data after overwritten and erased stored in the HDD 2. FIG. 9A, FIG. 9B and FIG. 9C correspond to states where the data has been overwritten and erased, shown in FIG. 2A, FIG. 2B and FIG. 2C, respectively. As shown in FIG. 9A, the entry information 21 shows that the file A has been erased. In order to erase the file, for example, it is sufficient that the first character of the file name is erased. As shown in FIG. 9B, the linkage of each cluster is canceled in the FAT information 22. Also, as shown in FIG. 9C, the clusters in which the data overwritten and erased were stored stores the overwritten invalid data.

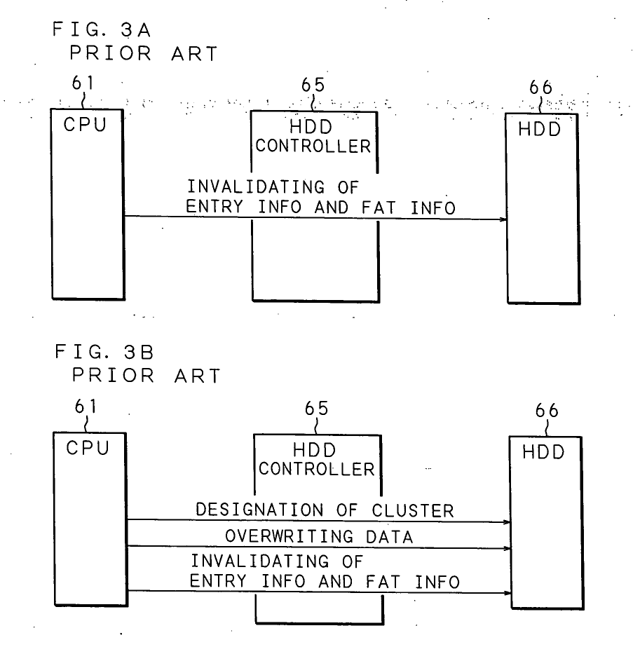

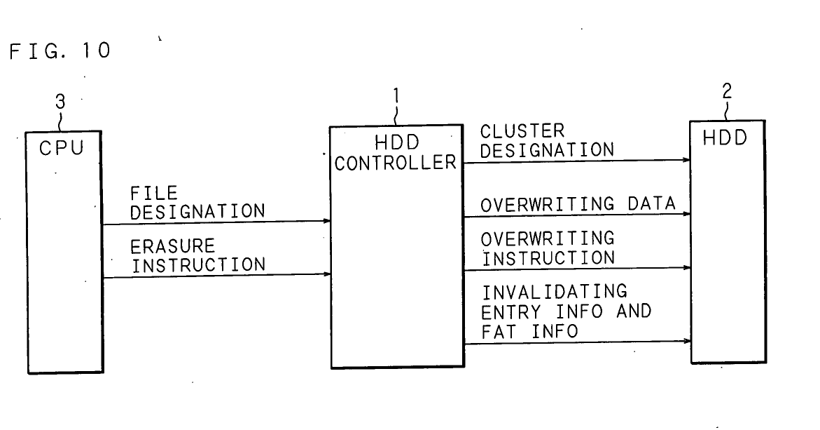

FIG. 10 is a schematic diagram conceptually showing the process of overwriting and erasing data in the information processing apparatus according to Embodiment 1 of the invention. The CPU 3 output and gives the file designation for data and the erasing instruction of data to the HDD controller 1. The HDD controller 1 outputs and gives designation of the cluster into which the overwriting data is written, the overwriting data, the overwriting instruction, the invalidating instruction of the entry information 21 and FAT information 22 to the HDD 2. In the prior art shown in FIG. 3B, the CPU 3 itself generates overwriting data and directly designates clusters, thereby overwriting with the overwriting data and invalidating the entry information 21 and the FAT information 22. In contrast, in Embodiment 1 of the invention, the HDD controller 1 performs these processes in place of the CPU 3. This relieves a burden on the CPU 3 required for overwriting and erasing the data and reduces the transfer amount of data between the CPU 3 and the HDD controller 1. Accordingly, the invention will improve the processing efficiency and processing speed of the information processing apparatus. Also, as its CPU has not to be of a highly process efficient type, the information processing apparatus can be suppressed in cost.

According to the invention, overwritten and erased data is invalidated by canceling the association between the file name and the clusters included in the entry information 21 after the overwriting with the overwriting data. Consequently, a file is deleted on a file system, so that the clusters of the HDD 2, in which data is overwritten and erased, can be immediately used for storing new data.

According to the invention, the CPU 3 instructs the HDD controller 1 of the type of overwriting data or the number of times of overwriting as a method of erasing a file, and the HDD controller 1 overwrites and erases data in accordance with the instructed method. This permits the data erasing to be performed on the basis of the degree of importance which is determined by the quality and security of the data.

When the information processing apparatus is stopped due to electrical failure or systematic breakdown during the data overwriting and erasing process, the data to be erased may partially remain in the HDD 2. The invention permits the entry information 21 to be written with the erasure request information prior to the writing of the overwriting data. When any file recording the erasure request information is found in the entry information 21 upon power-on, its data can be erased. Accordingly, the data remaining not erased due to the electrical failure or the systematic breakdown will successfully be erased.

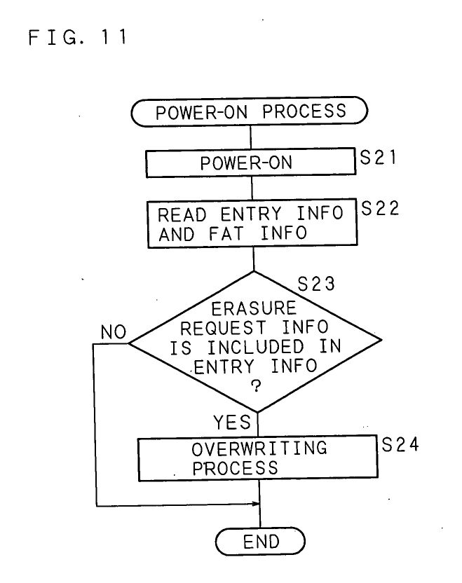

FIG. 11 is a flowchart showing procedures performed upon power-on by the information processing apparatus according to Embodiment 1 of the invention. When the information processing apparatus is turned on (S21), the HDD controller 1 reads out the entry information 21 and the FAT information 22 stored in the HDD 2 (S22). The HDD controller 1 then judges whether or not the erasure request information is included in the read out entry information 21 (S23). When the erasure request information is included in the read out entry information 21 (YES in S23), the information processing apparatus performs the overwriting process for overwriting and erasing the data of a file that the erasure request information is associated with the file name in the entry information 21 (S24). The overwriting processes in step S24 are similar to those in steps S110 to S121 shown in FIG. 6 and FIG. 7. When the process has been completed in step S24 or the erasure request information is not included in the entry information 21 in step S23 (NO in S23), the information processing apparatus terminates this process.

According to the invention, the erasure request information associated with the file name of the data to be erased is recorded in the entry information 21 prior to the writing of the overwriting data into the data to be erased. Upon power-on, the entry information 21 is examined. When the erasure request information is recorded in the entry information 21, the data of a file associated with the erasure request information is overwritten and erased. According to the invention, accordingly, the data to be erased can successfully be overwritten and erased upon power-on even if the information processing apparatus is stopped during the overwriting and erasing process, thus contributing to the improvement of data security in the information processing apparatus.

In the flowcharts shown in FIG. 6 and FIG. 7, the HDD controller 1 sequentially performs the process of receiving the erasing command of data transmitted from the CPU 3, the process of writing the erasure request information into the entry information 21 of the HDD 2, and the process of writing the overwriting data in the HDD 2. Alternatively, the processes of the HDD controller 1 may be performed not in a sequence. For example, upon receiving plural erasing commands from the CPU 3, the HDD controller 1 stores the commands in a receiving order and performs the process of each erasing command in accordance with storing order. Accordingly, the information processing apparatus can perform processes for erasing the data of plural files in a succession. The HDD controller 1 can also write the erasure request information into the entry information 21 in association with a file designated by the file designating information included in each of the erasing commands prior to the process of writing overwriting data in accordance with the erasing command.

Moreover, while Embodiment 1 uses FAT as an example, the HDD controller 1 as the storage control apparatus of the invention may be arranged compatible with plural types of file system. For example, the computer program 13 of the invention includes plural programs for controlling input/output of information to/from the HDD 2 corresponding to the types of file system, whereby the controlling method can be set according to type of the file system used by the CPU 3. When the CPU 3 inputs/outputs information to/from the HDD 2, e.g., the CPU 3 formats the HDD 2, the HDD controller 1 performs a process of setting a control method so as to control the input/output of information to/from the HDD 2 by a control method according to a file system used by CPU 3 for managing the data stored in the HDD 2.

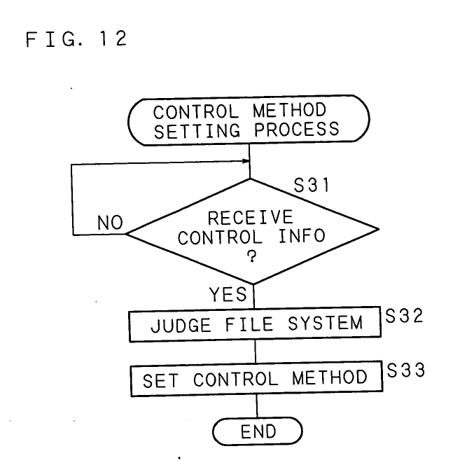

FIG. 12 is a flowchart showing a process of setting a control method by the HDD controller 1 as the storage control unit of the invention. In the state where no control method is set, the HDD controller 1 monitors reception of control information transmitted from the CPU 3 for instructing input/output of information to/from the HDD 2, e.g., instructing format of the HDD 2 (S31). When the control information is not received from the CPU 3 (NO in S31), the HDD controller 1 continues to monitor reception of control information. When receiving the control information transmitted from the CPU 3 (YES in S31), the HDD controller 1 judges the file system used by the CPU 3 in correspondence with contents of the received control information (S32). Then, the HDD controller 1 sets a control method according to the judgment result of the file system so that the input/output of information to/from the HDD 2 can be controlled by a control method according to the file system used by the CPU 3 for managing the data stored in the HDD 2 (S33). Thus, this process terminates. After setting of the control method, the HDD controller 1 controls the input/output of information to/from the HDD 2 with the use of the set control method.

According to Embodiment 1 of the invention, the HDD controller 1 controls the input/output of information to/from the HDD 2 with the use of the control method according to the file system used by the CPU 3. In other words, the use of the HDD controller 1 stands regardless of the types of the file system. As a result, either the HDD controller 1 or the storage device in which the HDD controller 1 and the HDD 2 connected to each other can be used in various information processing apparatuses such as a PC, a server and an image processing apparatus, with no need of their selective employment depending on the applications.

In Embodiment 1, the HDD controller 1 is connected with one HDD 2; however, the invention is not limited to this embodiment. The HDD controller 1 may be connected with plural HDDs 2, 2, . . . to control each HDD 2.

### Embodiment 2

In Embodiment 2, the HDD 2 as a storage unit or an external storage device generates overwriting data by itself. An internal configuration of an information processing apparatus according to Embodiment 2 is identical to that of the information processing apparatus according to Embodiment 1 shown in FIG. 4A and FIG. 4B; therefore, description thereof will be omitted.

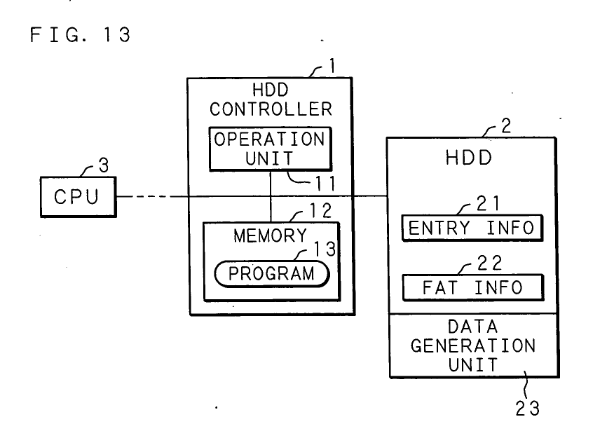

FIG. 13 is a functional block diagram showing functions of the HDD controller 1 and the HDD 2 according to Embodiment 2. The HDD 2 comprises a data generating unit 23 for performing an arithmetic operation to generate overwriting data including data of all “0” or nonsense data such as random data utilizing a random number. As the other internal configurations of the HDD 2 and the internal arrangement of the HDD controller 1 are identical to those of Embodiment 1, corresponding components are denoted by same reference numerals and description thereof will be omitted.

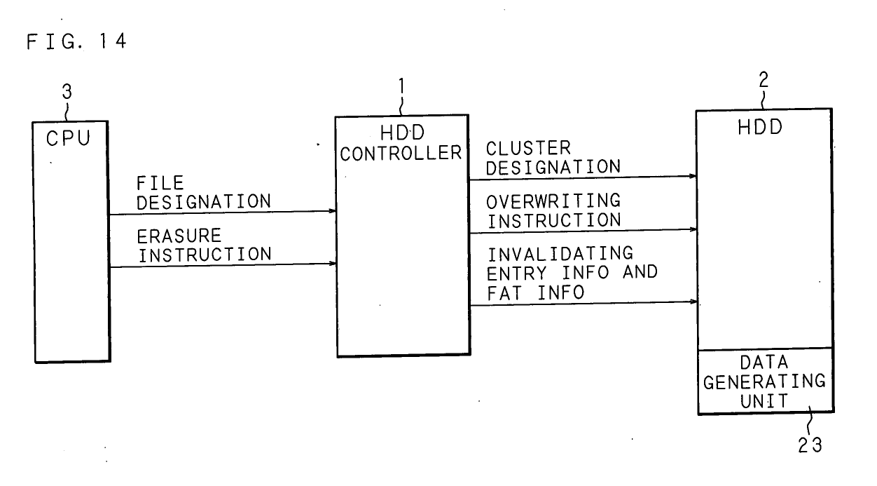

FIG. 14 is a schematic diagram conceptually showing a process of overwriting and erasing data in Embodiment 2. The CPU 3 outputs and gives to the HDD controller 1 designation of a file of data to be erased and an erasing instruction of data. The HDD controller 1 in turn outputs and gives to the HDD 2 designation of clusters into which the overwriting data is written, an instruction for overwriting the designated clusters, and an instruction for invalidating the entry information 21 and the FAT information 22. The data generating unit 23 of the HDD 2 generates the overwriting data in accordance with the overwriting instruction. The HDD 2 writes the overwriting data generated by the data generating unit 23 into the designated clusters to invalidate the entry information 21 and the FAT information 22.

While the overwriting data is generated by the HDD controller 1 in Embodiment 1, the overwriting data is generated by the data generating unit 23 of the HDD 2 in Embodiment 2. This reduces a burden on the HDD controller 1 required for overwriting and erasing the data, and reduces the transfer amount of data between the HDD controller 1 and the HDD 2. Accordingly, the information processing apparatus in Embodiment 2 can be increased in the efficiency and speed of the process. Also, since the HDD controller 1 is configured as a part of the control unit, such as the I/O controller 41 or the second system controller 43, for controlling the input/output of information to/from the external interface 42 as shown in FIG. 4A and FIG. 4B, its control process efficiency for the external interface 42 is decreased if the transfer amount of data between the HDD controller 1 and the HDD 2 is large. According to the invention, however, the transfer amount of data between the HDD controller 1 and the HDD 2 can be reduced; therefore, it is possible to improve the efficiency of the process of controlling the input/output of information to/from a device other than the HDD 2.

As this invention may be embodied in several forms without departing from the spirit of essential characteristics thereof, the present embodiments are therefore illustrative and not restrictive, since the scope of the invention is and all changes that fall within metes and bounds of the claims, or equivalence of such meters and bounds thereof are therefore intended to be embraced by the claims.

1. An information processing apparatus comprising: an information processing unit which processes information; a storage unit which stores data on a file basis; and a storage control unit which is connected to said information processing unit and said storage unit and controls input/output of information to/from said storage unit, wherein
said information processing unit comprises means for outputting, to said storage control unit, file designating information for designating a file and a file erasing instruction for instructing erasing of a file designated by said file designating information,
said storage control unit comprises:
address specifying means for specifying an address in said storage unit storing data of a file designated by said file designating information outputted from said information processing unit;
data generating means for generating overwriting data for overwriting and erasing data; and
means for, in accordance with a file erasing instruction outputted from said information processing unit, outputting, to said storage unit, overwriting data generated by said data generating means, address designating information for designating an address of said storage unit specified by said address specifying means, and a data writing instruction for instructing writing of said overwriting data into said address, and said storage unit comprises means for, in accordance with a data
writing instruction outputted from said storage control unit, writing said overwriting data outputted from said storage control unit into an address designated by said address designating information outputted from said storage control unit.

2. The information processing apparatus as set forth in claim 1, wherein
said storage unit stores correspondence information for corresponding a file and an address storing said file to each other, and
said address specifying means specifies, by referring said correspondence information, an address of said storage unit storing data of a designated file.

3. An information processing apparatus comprising: an information processing unit which processes information; a storage unit which stores data on a file basis; and a storage control unit which is connected to said information processing unit and said storage unit and controls input/output of information to/from said storage unit, wherein
said information processing unit comprises means for outputting, to said storage control unit, file designating information for designating a file and a file erasing instruction for instructing erasing of a file designated by said file designating information,
said storage control unit comprises:
address specifying means for specifying an address in said storage unit storing data of a file designated by said file designating information outputted from said information processing unit; and
means for, in accordance with a file erasing instruction outputted from said information processing unit, outputting, to said storage unit, address designating information for designating an address of said storage unit specified by said address specifying means, and a data writing instruction for instructing writing of overwriting data for overwriting and erasing data into said address, and
said storage unit comprises:
data generating means for generating overwriting data; and
means for, in accordance with a data writing instruction outputted from said storage control unit, writing overwriting data generated by said data generating means into an address designated by said address designating information outputted from said storage control unit.

4. The information processing apparatus as set forth in claim 3, wherein
said storage unit stores correspondence information for corresponding a file and an address storing said file to each other, and
said address specifying means specifies, by referring said correspondence information, an address of said storage unit storing data of a designated file.

5. A storage device comprising: a storage unit which stores data on a file basis; and a storage control unit which is connected to said storage unit and controls input/output of information to/from said storage unit, wherein
said storage control unit comprises:
receiving means for receiving, from the outside, file designating information for designating a file, and a file erasing instruction for instructing erasing of a file designated by said file designating information;
address specifying means for specifying an address of said storage unit storing data of a file designated by said file designating information received by said receiving means;
data generating means for generating overwriting data for overwriting and erasing data; and
means for, in accordance with a file erasing instruction received by said receiving means, outputting, to said storage unit, overwriting data generated by said data generating means, address designating information for designating an address of said storage unit specified by said address specifying means, and a data writing instruction for instructing writing of said overwriting data into said address, and
said storage unit comprises means for, in accordance with a data writing instruction outputted from said storage control unit, writing overwriting data outputted from said storage control unit into an address designated by address designating information outputted from said storage control unit.

6. The storage device as set forth in claim 5, wherein
said storage unit stores correspondence information for corresponding a file and an address storing said file to each other, and
said address specifying means specifies, by referring said correspondence information, an address of said storage unit storing data of a designated file.

7. A storage device comprising: a storage unit which stores data on a file basis; and a storage control unit which is connected to said storage unit and controls input/output of information to/from said storage unit, wherein
said storage control unit comprises:
receiving means for receiving, from the outside, file designating information for designating a file, and a file erasing instruction for instructing erasing of a file designated by said file designating information;
address specifying means for specifying an address of said storage unit storing data of a file designated by said file designating information received by said receiving means; and
means for, in accordance with a file erasing instruction received by said receiving means, outputting, to said storage unit, address designating information for designating an address of said storage unit specified by said address specifying means, and a data writing instruction for instructing writing of overwriting data for overwriting and erasing data into said address, and
said storage unit comprises:
data generating means for generating overwriting data; and
means for, in accordance with a data writing instruction outputted from said storage control unit, writing overwriting data generated by said data generating means into an address designated by said address designating information outputted from said storage control unit.

8. The storage device as set forth in claim 7, wherein
said storage unit stores correspondence information for corresponding a file and an address storing said file to each other, and
said address specifying means specifies, by referring said correspondence information, an address of said storage unit storing data of a designated file.

9. A storage control apparatus which can be connected to an external storage device for storing data on a file basis and controls input/output of information to/from said connected external storage device, comprising:
receiving means for receiving, from the outside, file designating, information for designating a file stored in said external storage device, and a file erasing instruction for instructing erasing of a file designated by said file designating information;
address specifying means for specifying an address of said external storage device storing data of a file designated by said file designating information received by said receiving means;
data generating means for generating overwriting data for overwriting and erasing data; and
transmitting means for, in accordance with a file erasing instruction received by said receiving means, transmitting, to said external storage device, overwriting data generated by said data generating means, address designating information for designating an address of said external storage device specified by said address specifying means, and a data writing instruction for instructing writing of said overwriting data into said address.

10. The storage control apparatus as set forth in claim 9, wherein
said external storage device stores correspondence information for corresponding a file and an address storing said file to each other, and
said address specifying means specifies, by referring said correspondence information, an address of said external storage device storing data of a designated file.

11. The storage control apparatus as set forth in claim 10, wherein said address specifying means judges a type of a file system constructed in said external storage device, and refers to said correspondence information on the basis of a type of said judged file system.

12. The storage control apparatus as set forth in claim 9, wherein
said external storage device stores correspondence information for corresponding a file and an address storing said file to each other, and
said storage control apparatus further comprises transmitting means for transmitting a canceling instruction, which instructs that said correspondence information stored in said external apparatus is updated so that said correspondence between a file designated by said file designating information and an address storing said file is canceled, to said external storage device after completion of writing of said overwriting data.

13. The storage control apparatus as set forth in claim 12, further comprising transmitting means for transmitting a writing instruction, which instructs that erasure request information indicative of a request for erasing a file designated by said file designating information is written into said correspondence information stored in said external storage device in association with said file, to said external storage device prior to transmission of said data writing instruction by said transmitting means.

14. The storage control apparatus as set forth in claim 13, further comprising:
correspondence information reading means for, upon power-on, reading out said correspondence information stored in said external storage device;
judging means for judging whether or not said correspondence information read by said correspondence information reading means includes said erasure request information; and
means for, when said judging means judging that said correspondence information includes said erasure request information, performing the same process as that in the case where said receiving means receives a file erasing instruction for instructing erasing of a file associated with said erasure request information by said correspondence information.

15. The storage control apparatus as set forth in claim 9, wherein
said receiving means receives, from the outside, an erasing method instruction for instructing a method for erasing a file together with said file erasing instruction, and
said transmitting means transmits said data writing instruction, which instructs that said overwriting data is written into said address by a method realizing said method in accordance with said erasing method instruction, to said external storage device.

16. The storage control apparatus as set forth in claim 15, further comprising:
file erasing instruction storing means for storing plural file erasing instructions received by said receiving means in a receiving order; and
means for performing processes in accordance with plural file erasing instructions stored in said file erasing instruction storing means in said stored order.

17. The storage control apparatus as set forth in claim 16, which can control input/output of information to/from said external storage device by plural control methods, and
further comprises: means for receiving, from the outside, control information relating to input/output of information to/from said external storage device; and means for setting a control method for controlling said external storage device by a control method according to said control information received by said means.

18. A storage control apparatus which can be connected to an external storage device for storing data on a file basis and controls input/output of information to/from said connected external storage device, wherein
said storage control apparatus can be connected to an external storage device having means for generating overwriting data for overwriting and erasing data, and comprises:
receiving means for receiving, from the outside, file designating information for designating a file stored in said connected external storage device, and a file erasing instruction for instructing erasing of a file designated by said file designating information;
address specifying means for specifying an address of said external storage device storing data of a file designated by said file designating information received by said receiving means; and
transmitting means for, in accordance with a file erasing instruction received by said receiving means, transmitting, to said external storage device, address designating information for designating an address of said external storage device specified by said address specifying means, and a data writing instruction for instructing generation of overwriting data and writing of said generated overwriting data into said address.

19. The storage control apparatus as set forth in claim 18, wherein
said external storage device stores correspondence information for corresponding a file and an address storing said file to each other, and
said address specifying means specifies, by referring said correspondence information, an address of said external storage device storing data of a designated file.

20. The storage control apparatus as set forth in claim 19, wherein said address specifying means judges a type of a file system constructed in said external storage device, and refers to said correspondence information on the basis of a type of said judged file system.

21. The storage control apparatus as set forth in claim 18, wherein
said external storage device stores correspondence information for corresponding a file and an address storing said file to each other, and
said storage control apparatus further comprises transmitting means for transmitting a canceling instruction, which instructs that said correspondence information stored in said external apparatus is updated so that said correspondence between a file designated by said file designating information and an address storing said file is canceled, to said external storage device after completion of writing of said overwriting data.

22. The storage control apparatus as set forth in claim 21, further comprising transmitting means for transmitting a writing instruction, which instructs that erasure request information indicative of a request for erasing a file designated by said file designating information is written into said correspondence information stored in said external storage device in association with said file, to said external storage device prior to transmission of said data writing instruction by said transmitting means.

23. The storage control apparatus as set forth in claim 22, further comprising:
correspondence information reading means for, upon power-on, reading out said correspondence information stored in said external storage device;
judging means for judging whether or not said correspondence information read by said correspondence information reading means includes said erasure request information; and
means for, when said judging means judging that said correspondence information includes said erasure request information, performing the same process as that in the case where said receiving means receives a file erasing instruction for instructing erasing of a file associated with said erasure request information by said correspondence information.

24. The storage control apparatus as set forth in claim 18, wherein
said receiving means receives, from the outside, an erasing method instruction for instructing a method for erasing a file together with said file erasing instruction, and
said transmitting means transmits said data writing instruction, which instructs that said overwriting data is written into said address by a method realizing said method in accordance with said erasing method instruction, to said external storage device.

25. The storage control apparatus as set forth in claim 24, further comprising:
file erasing instruction storing means for storing plural file erasing instructions received by said receiving means in a receiving order; and
means for performing processes in accordance with plural file erasing instructions stored in said file erasing instruction storing means in said stored order.

26. The storage control apparatus as set forth in claim 25, which can control input/output of information to/from said external storage device by plural control methods, and
further comprises: means for receiving, from the outside, control information relating to input/output of information to/from said external storage device; and means for setting a control method for controlling said external storage device by a control method according to said control information received by said means.

27. A computer program product for controlling a computer which is connected with an external storage device for storing data on a file basis and inputs/outputs information to/from said external storage device, wherein said computer program product comprises:
a computer readable storage medium having computer readable program code means embodied in said medium, said computer readable program code means comprising computer instruction means for:
when receiving, from the outside, file designating information for designating a file stored in said external storage device, and a file erasing instruction for instructing erasing of a file designated by said file designating information, specifying an address of said external storage device storing data of a file designated by the received file designating information;
generating overwriting data for overwriting and erasing data; and
transmitting, in accordance with the received file erasing instruction, to said external storage device, generated overwriting data, address designating information designating a specified address of said external storage device, and a data writing instruction for instructing writing of said overwriting data into said address.

28. A computer program product for controlling a computer which is connected with an external storage device for storing data on a file basis and inputs/outputs information to/from said external storage device, wherein said computer program product comprises:
a computer readable storage medium having computer readable program code means embodied in said medium, said computer readable program code means comprising computer instruction means for:
when receiving, from the outside, file designating information for designating a file stored in an external storage device which generates overwriting data for overwriting and erasing data, and a file erasing instruction for instructing erasing of a file designated by said file designating information, specifying an address of said external storage device storing data of a file designated by the received file designating information; and
transmitting, in accordance with the received file erasing instruction, to said external storage device, address designating information designating a specified address of said external storage device, and a data writing instruction for instructing generation of overwriting data and writing of said overwriting data into said address.
